(19) United States
(12) Patent Application Publication
(10) Pub. No.: US 2003/0036932 A1
(43) Pub. Date: Feb. 20, 2003

(54) Method of implementation suitable for detailed list shopping mode in B to B web site products

(76) Inventors: Kuang Shin Lin, Taipei (TW); Wen Feng Hsing, Tianjin (CN)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/207,967

(22) Filed: Jul. 31, 2002

(30) Foreign Application Priority Data
Aug. 3, 2001 (TW) 90118957

(51) Int. Cl. G06F 17/60

(52) U.S. Cl. 705/5

(57) ABSTRACT

An implementation method suitable for detailed list shopping mode in B to B web site products comprises the following steps: (1) a Server writes a product order signal to be displayed into a display string and downloading to a Client; (2) clients of the Client write and modify an order data according to the display string, then upload to the Server; (3) the Server registers the signal and stores the signal in a Session array to generate a reservation order and send it back to the Client; (4) the Client displays the reservation order of the product and admits the clients to modify relevant information; after the clients confirm, the reservation order is uploaded to the Server again; and (5) after the Server receives the reservation order, the reservation order is written into a database of the Server and encrypted to store.

### BACKGROUND OF THE INVENTION

1. Field of the Invention

The invention relates to a method for web site shopping through the Internet, and more particularly, to an implementation method suitable for detailed list shopping mode in B to B web site products.

2. Related Art

Presently, e-commerce web sites on the Internet have a shopping mode of “shopping cart” in which “virtual customers” navigate through web pages of products, choose desired products with a mouse, put them in a “virtual shopping cart” on the web page, and support a backstage data structure of the web page while the products chosen by the client are listed on a new page to show the “virtual customers.” By the present method to perform e-commerce, B to C (business to customer) web sites are suitable. If it is used in B to B (business to business) web sites, there are many inconveniences . For example,

(1) first, when a client (merchant) is ordering, s/he cannot see an entire product list provided by the web site directly;

(2) once the customer orders the product, s/he cannot modify or continue to order other products on a same interface immediately;

(3) every time the client orders the product, s/he must browse every page of entire “virtual web shop” one by one;

(4) the order page is displayed on the browser of the Client records order information of the client; if there is another web page counting the order data, the client must switch between the two pages when s/he gathers statistics, continuously orders, or modifies the order repeatedly; the operation is complicated and the program is not easy to maintain;

(5) in common B to C e-commerce web sites, in the process of ordering the client can click other links and leave the order page any time to terminate the order, which affects the normal operations of the Client and the database of the Server.

The above mentioned conditions cause much inconvenience to the merchant client of the e-commerce web site of B to B.

### SUMMARY OF THE INVENTION

It is therefore a primary objective of the invention to provide an implementation method suitable for detailed list shopping mode in B to B web site products to solve the above mentioned problems.

According to the claimed invention, the implementation method suitable for detailed list shopping mode in B to B web site products comprises the following steps: (1) a Server writes a product order signal to be displayed into a display string and downloaded to a Client; (2) clients of the Client write and modify order data according to the display string, then upload to the Server; (3) the Server registers the signal and stores the signal in a Session array to generate a reservation order and sends back to the Client; (4) the Client displays the reservation order of the product and admits the clients to modify related information; after the clients confirm, the reservation order is uploaded to the Server again; and (5) after the Server receives the reservation order, the reservation order is written into a database of the Server and encrypted to store.

An advantage of the invention is that its method is not only suitable for B to B web sites, but also allows the merchant to see a page, choose products completely, count shopping amount and money immediately, and modify or continuously order any time. The merchant's various requirement can thus be met.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a diagram of the hardware structure of the invention.

FIG. 2 is a flow chart of the main functions of the invention.

FIG. 3 is a flow chart of the invention in processing strings to be displayed by the Server.

FIGS. 4, 4A, 4B, 4C are flow charts of the invention in displaying product order signals and modifying by the Client.

FIG. 5 is a flow chart of the invention in generating product order reservation orders by the Client.

FIG. 6A is a flow chart of the invention in displaying processed reservation signals by the Server and the Client.

FIG. 6B is a flow chart of the invention in displaying relevant information by the Client.

FIG. 7 is a flow chart of the invention in writing a database by the Server.

FIG. 8 is a display page of the product order list of the preferred embodiment of the invention.

FIG. 9 is a partial magnification diagram of the product order data signal statistics window of the preferred embodiment of the invention.

FIG. 10 is a product reservation order page of the preferred embodiment of the invention.

FIG. 11 is a product order list confirmation and display page of the preferred embodiment of the invention.

### DETAILED DESCRIPTION OF THE INVENTION

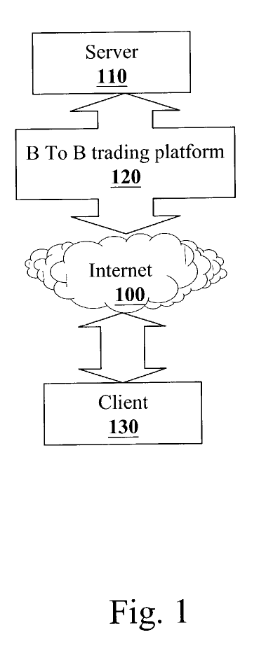

The invention provides an implementation method and hardware structure suitable for detailed list shopping mode in B to B web site products, as shown in FIG. 1. The invention builds on an Internet structure 100. A Server 110 performs data delivery through a B to B trading platform 120. A Client 140 performs processing and displaying of product order data then uploads the processed data to the Server 110. At the Server 110, the product order data uploaded by the Client 130 is processed, written into a database, and the registered order data is stored in the session array. The above mentioned process is performed repeatedly to complete B to B business transactions.

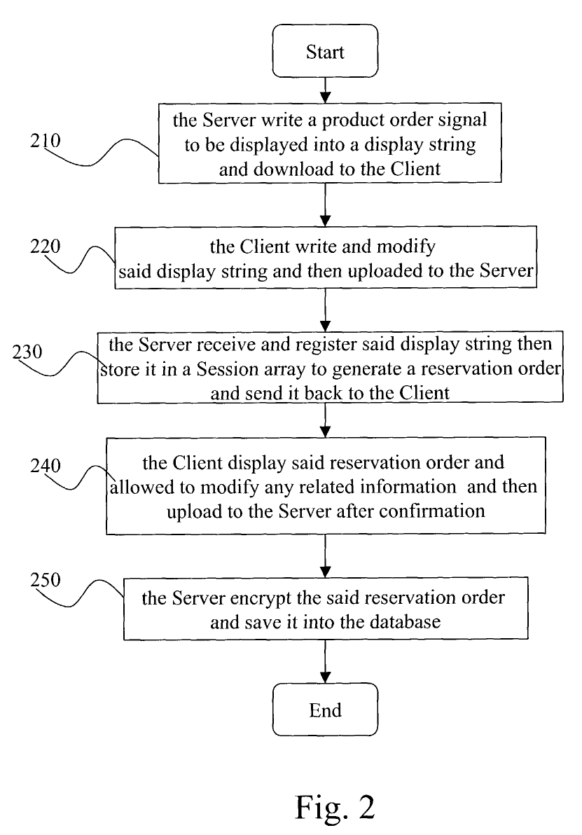

Please refer to FIG. 2, which is a flow chart of the main functions of the invention. The Server 110 writes a product order signal to be displayed into a display string and downloads to the Client 130 (step 210). When the Client 130 receives the string signals, they are displayed and provided to clients to write and modify. They are then uploaded to the Server 110 (step 220). When the Server receives the above mentioned signal, it registers the signal first. Next, it stores them in a Session array to generate a reservation order. After the reservation order is generated, the Server 110 sends it back to the Client 130 (step 230). The Client 130 displays the product reservation order and allows the client to modify related information. After the client's confirmation , the reservation order is uploaded to the Server 110 again (step 240). Finally, the Server 110 writes the received reservation order into the database and encrypts it (step 250).

The following flows introduce processing and displaying order data from the Server 110 and the Client 130 separately:

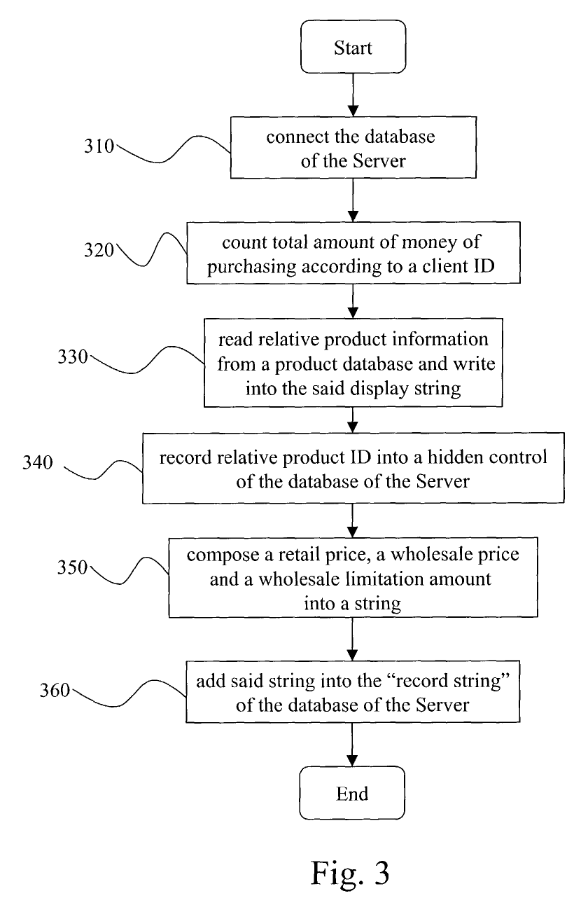

The flows of product order and display of the Server 110 are shown in FIG. 3. First, connect the database of the Server 110 (step 310). According to an ID logged in the web site by the client, count an accumulative total amount of money of purchasing by the client (step 320). Next, read relative information from a product database and write the signals into the strings to be displayed (step 330). Record the product ID corresponding to each product into a hidden control of the database of the Server 110 (step 340). Compose a retail price, a wholesale price, and a wholesale limitation of each product into a string (step 350). Add the string into the “record string” of the database of the Server 110, and display the string (step 360).

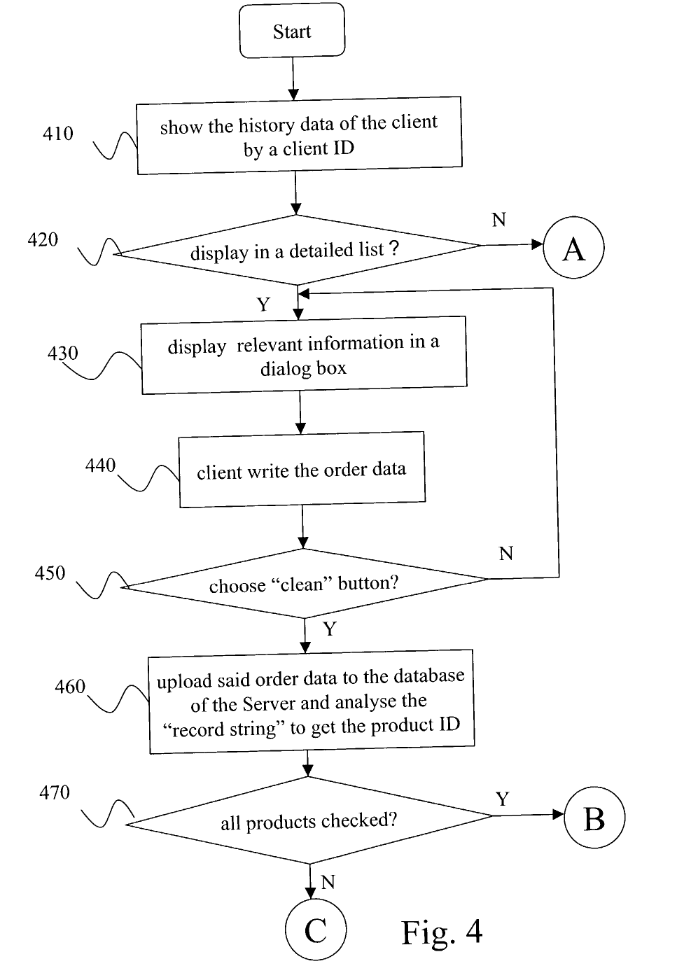

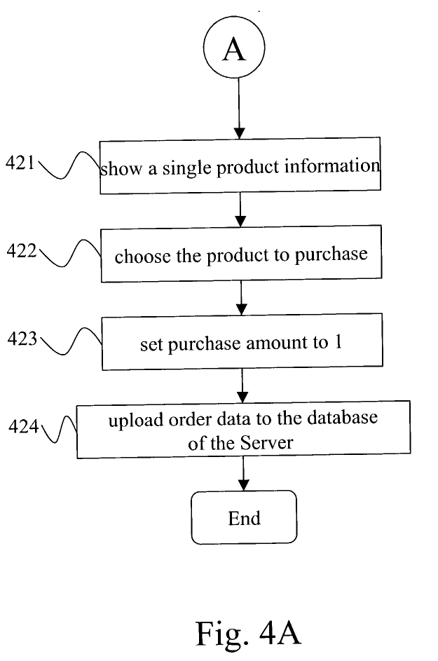

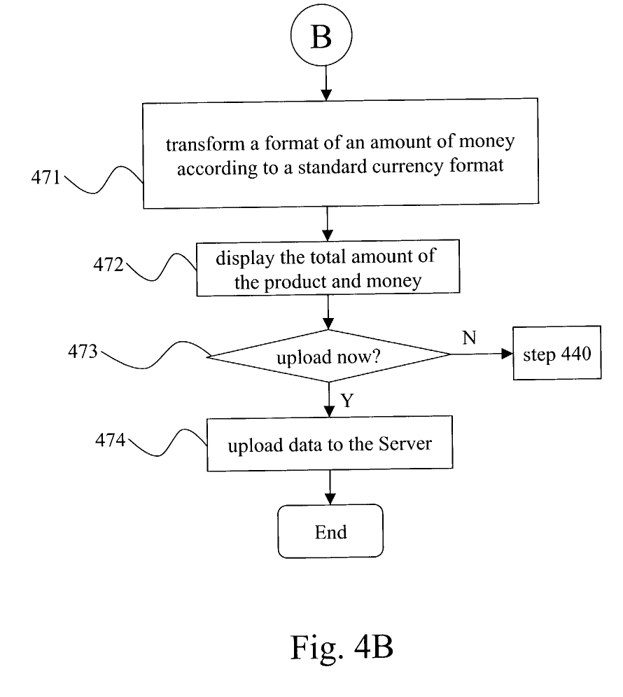

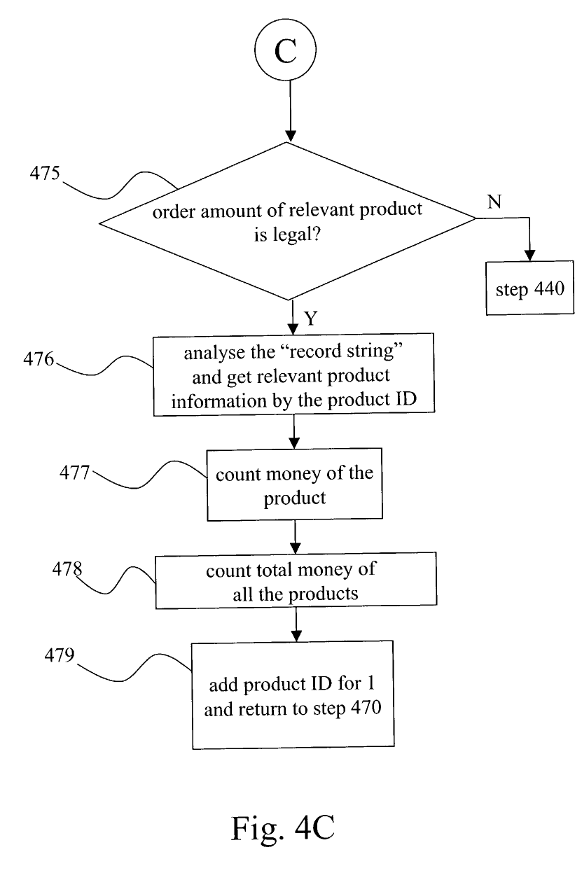

The product order and display flow of the Client 130 are shown in FIGS. 4, 4A, 4B, and 4C. At the Client 130, according to the ID logged into the web sites by the client, history data of the client is shown on the web page (step 410). It includes a past order total amount of money and connects to “preferential measures” related to the client to get the “preferential measures” that can be used by the client. At this time, choose whether to display a detailed list (step 420). If it is not displayed , but product signals displayed with a way of single product selectively, then go to step A, and display a single product signal directly (step 421). Next, choose the products to purchase (step 422), and set a purchase amount of the product as 1 (step 423). Finally, upload the data to the Server 110 (step 424).

If a detailed list is displayed , then display a dialog box of relevant information on the web page at the same time (step 430). The dialog box includes a product name, a linking route for introducing the product, a product wholesale price, a wholesale limitation, and a product order amount. Next, the client writes the order data (step 440). After the client fills in the order data, provide the client the option of choosing a “clean” button (step 450). If the client chooses the “clean” button , then the operations of the client are useless and go back to step 430 to await further input. If the client does not choose the “clean” button, then s/he chooses the “purchase” button. Then upload the product order data to the database of the Server, analyze the “record string” of the database, and get the product ID (including the amount) (step 460).

According to the ID, determine whether all the products are checked (step 470). If they are, then go to step B. According to a standard currency format, transform a format of an accumulative amount of money (step 471). Then display the total amount and the total amount of money of the order product (step 472) and ask the client whether to upload data immediately (step 473). If uploading data immediately is selected, then upload the data to the Server 110 (step 474). If the client chooses not to upload the data, then go back to step 440 to wait for the client to rewrite the order data.

If order products are not yet checked, then go to step C to further analyze whether the order amount corresponding to the product ID is a logic number (step 475). If it is not a logic number, then go back to step 440 to wait for the client to rewrite the order data. If it is a logic number, then analyze the “record string” and get relevant information according to the product ID (step 476), including three strings of prices, a product retail price, a product wholesale price, and a product wholesale limitation. Next, count the accumulative order amount of money of the product (step 477). Then count the accumulative amount of money of all the present order products (step 478). Finally, increase the product ID (ID=ID+1) and go back to step 470 to confirm whether all products are checked.

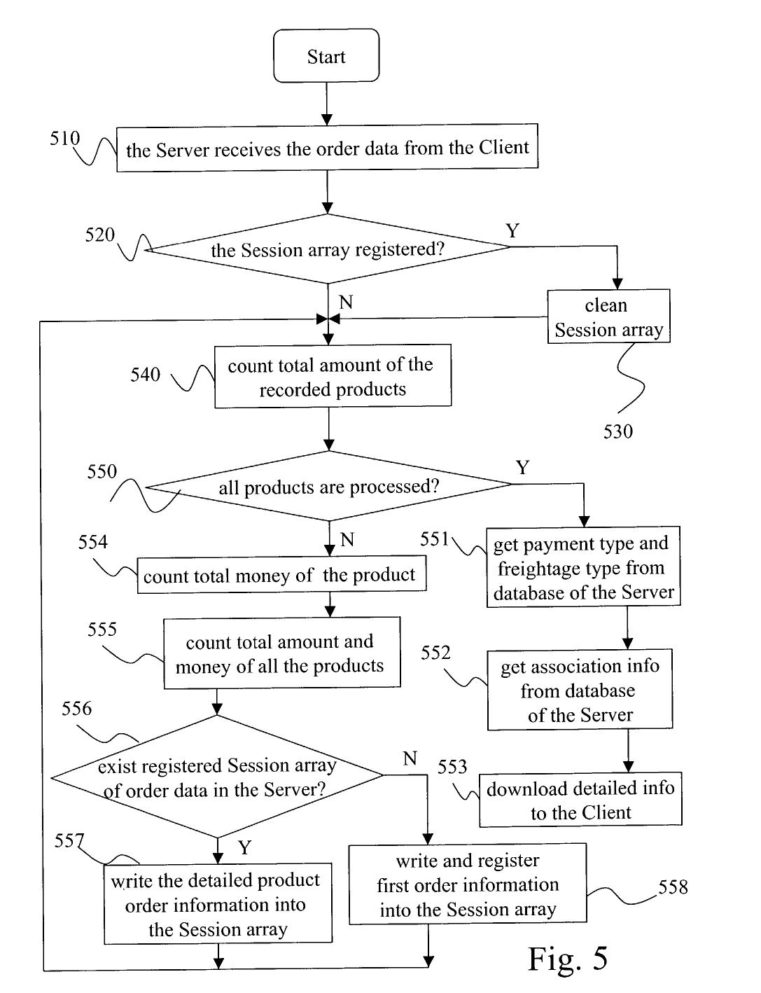

The flow of processing uploaded data by the Client at the Server 110 is shown in FIG. 5. The Server 110 receives the product order data uploaded from the Client 130 (step 510). First, determine whether the session array of recording order data is already registered (step 520). If it is registered, then clean the present session array of the Server 110 first (step 530) to prevent data from interfering with the continuous order data by the client. Then continuous processing is performed. If the session array of recording order data is not registered, then get the total amount of the recorded products according to the data uploaded from the Client 130 (step 540) and ask whether the order data of all the products are processed (step 550). When the order data of all products are processed, read the database of the Server 110 to get the payment type and the freightage type of the client (step 551) and the association signals of the client through the database of the Server 110 (step 552). Finally, download the product order details to the Client 130 for display (step 553), including statistics of prices and order amounts, selection of payment type of the client, selection of freightage type, and association signals of the clients.

If some product order data is not processed, then gather statistics of the amount of money of the order of the product (step 554). Count the total amount and the amount of money of the present order products (step 555) and determine whether the Server 110 exists in the registered session array for recording the product order data (step 556). If it exists, then write the product item numbers, the product serials, the order amount, and the sale price of the product order into the array (step 557), then go back to step 540. If the Server 110 doesn't exist in the above mentioned session array, then write a first signal of ordering products into the session array and register the array through the session (step 558), then go back to step 540.

The flow of displaying the processed order signal by the Server 110 at the Client 130 comprises:

(1) displaying the reservation order:

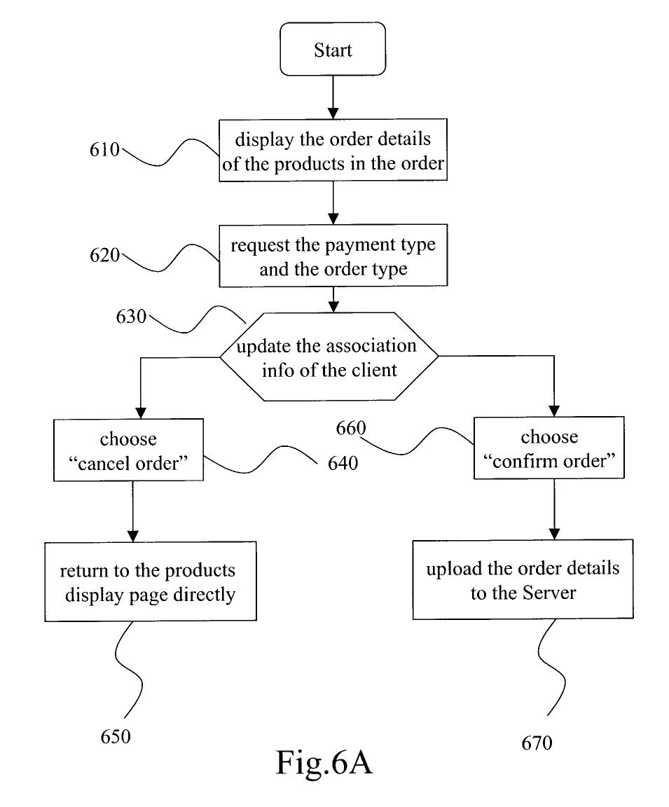

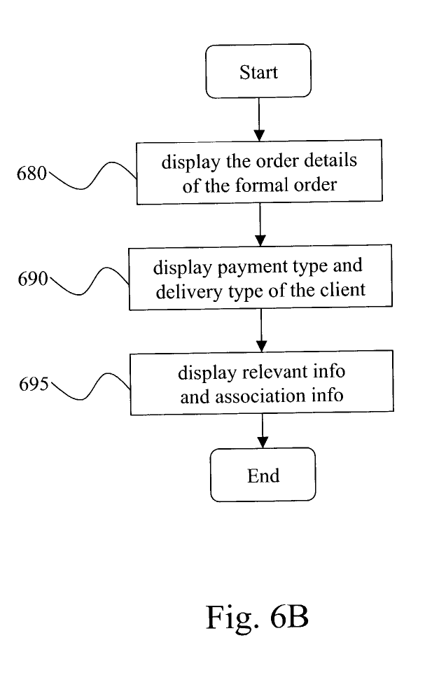

The Server 110 receives the data uploaded from the Client. After gathering statistics and registering, be reservation order data and send it back to the Client 130 to display. The flow is shown in FIG. 6A. At the Client 130, display the order details of the product in the orders (step 610). The client can request the payment type and the order type according to his or her own requirement (step 620). If necessary , the client can renew the association signals of the client (server?) (step 630). At this time, if the client chooses a “cancel order” (step 640), then the reservation order is not processed and returns to the product display page directly (step 650). If the client chooses a “confirm order” (step 660), then the order details of the reservation order are uploaded to the Server 110 (step 670).

(2) displaying a formal order:

As shown in FIG. 6B, after the above mentioned process, a formal order is obtained and shown to the Client 130. First, display the order details of the formal order (step 680). Display the payment type and the delivery type confirmed by the client (step 690). Finally, display the relevant signals and the client association (step 695). From here, the formal order is obtained.

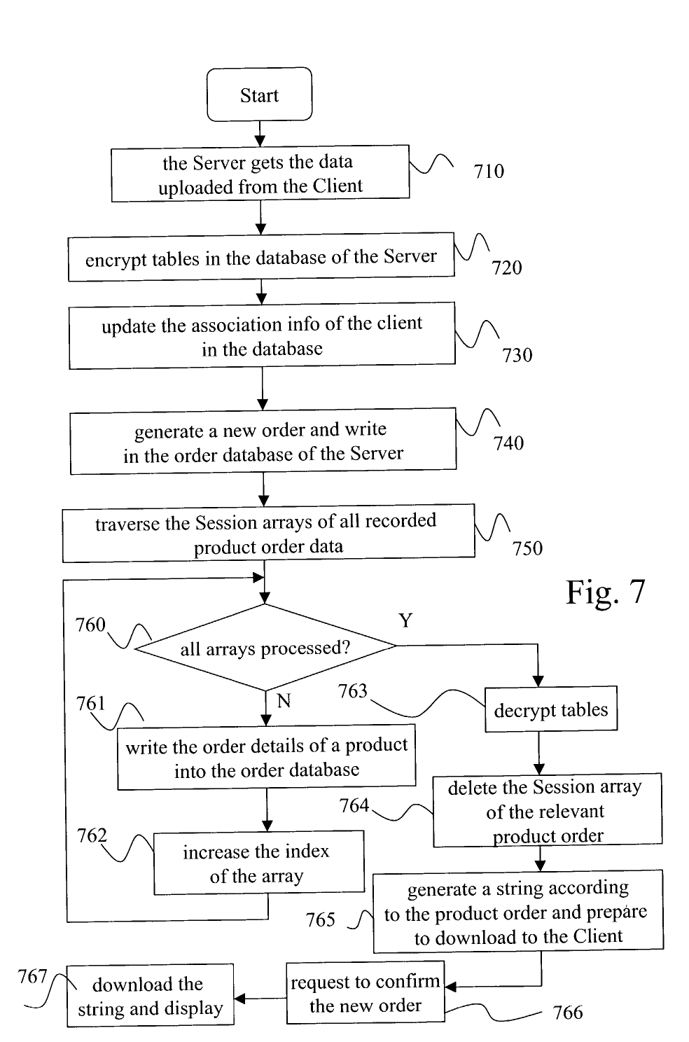

After the client confirms the formal order at the Client 130, it must be uploaded to the Server 110 again to write into the database. The flow is shown in FIG. 7. The Server 110 gets the data uploaded from the Client (step 710). Encrypt tables to be operated in the database of the Server 110 (step 720). Next, renew the association signals of the client in the database (step 730). According to the information of the ordered products, generate a new order and write in the order database in the Server 110 (step 740), including the product amount, the total amount of money, the ID signal of the client, the payment type, and the delivery type. Next, traverse the session arrays of recording the product order data (step 750) and determine whether all the arrays are processed (step 760). If they are not, then write the order details of a product recorded in an item into the order detail database (step 761). Next, increase the index of the array (array+1) (step 762) and go back to step 760. If all arrays are processed, then decrypt the tables in the database (step 763). Next, delete the session array of recording the product order data information (step 764). According to the product order and the order details, a string is generated and downloaded to the Client 130 to display (step 765). Find relevant people from the database and send emails to them to request to confirm the new order (step 766). Once confirmed, download the string to the Client 130 to display (step 767).

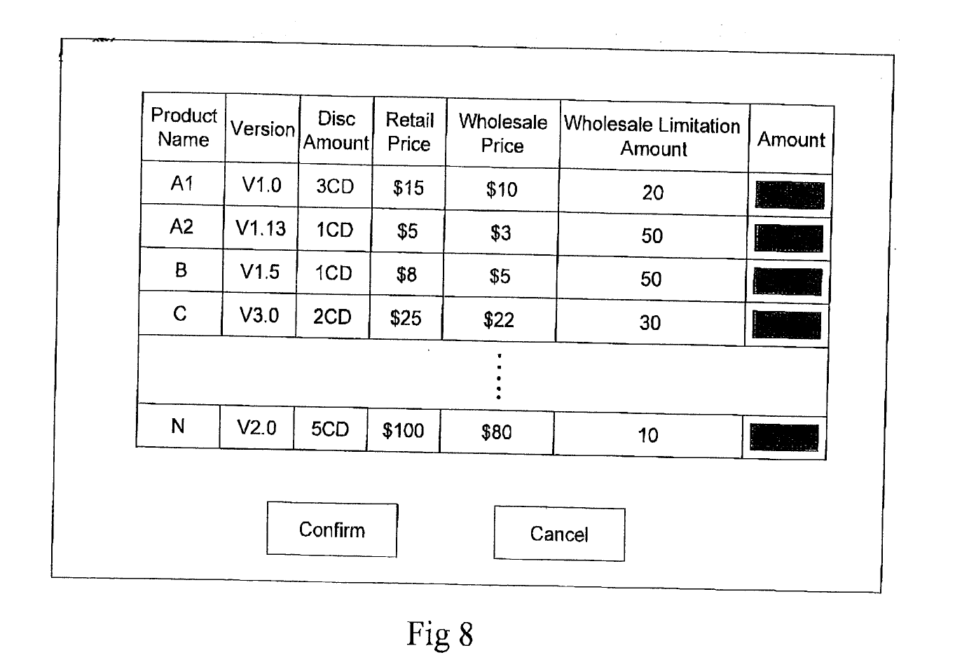

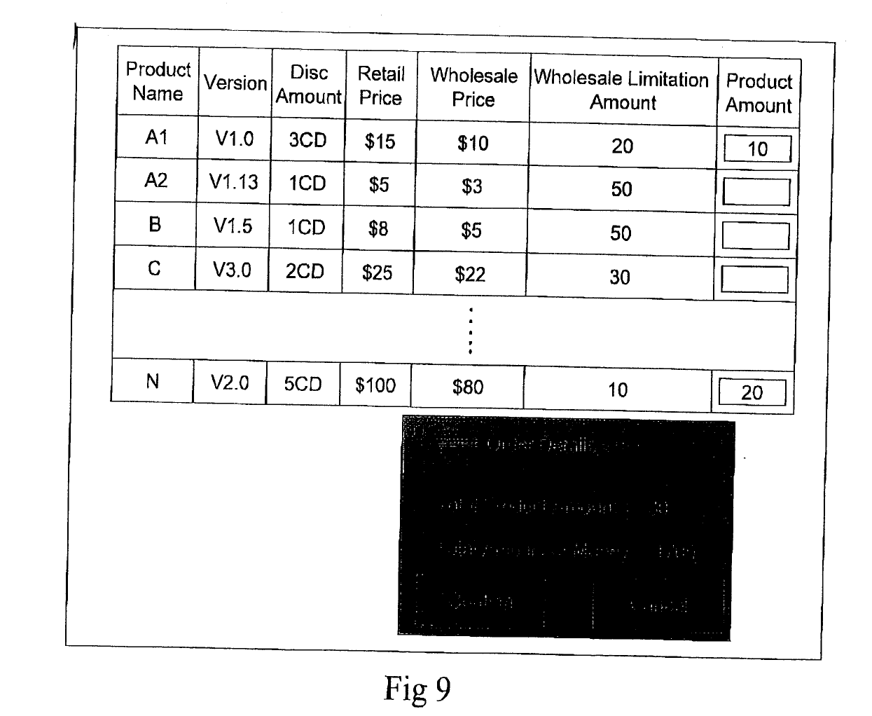

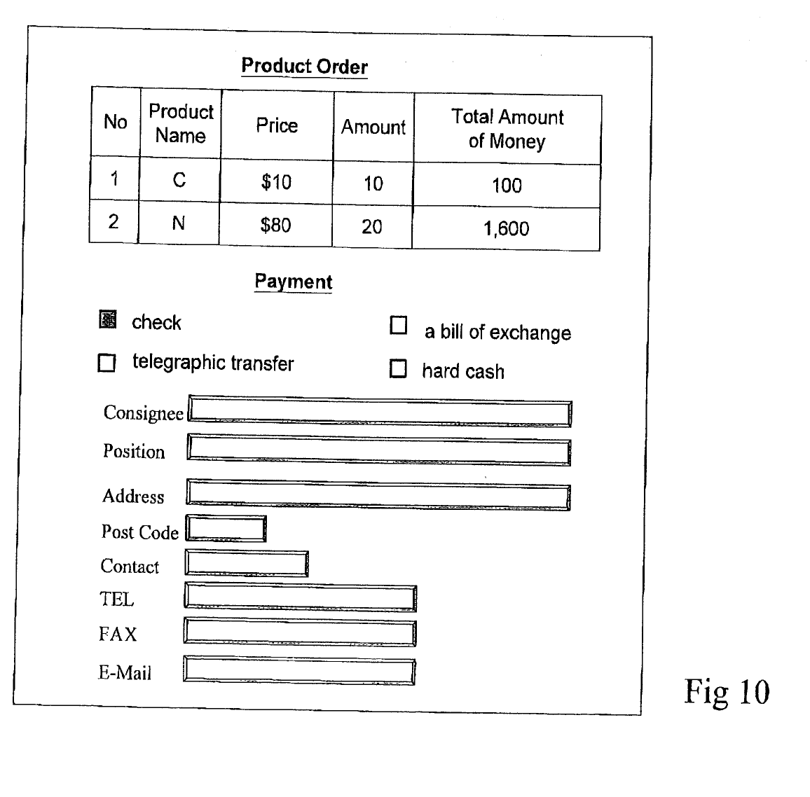

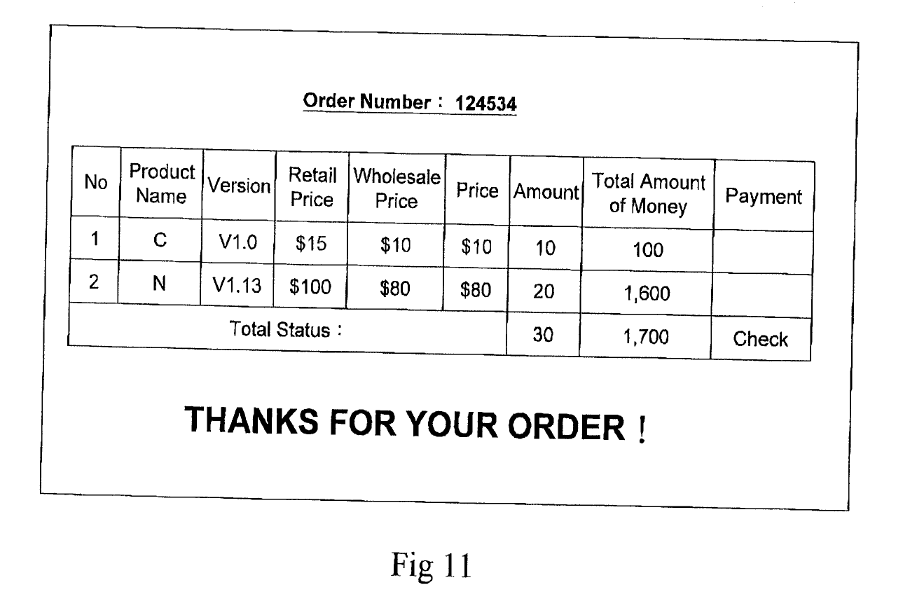

Now we take a preferred embodiment to describe the method of the invention. First, connect to a database of the Server 110 , open the database, and count the accumulative total purchase price or read product signals, including the product name, and relevant information (version number and numbers of a package) according to the registered ID. Write them into the string to be displayed, and add the hidden control to record the corresponding product ID. Compose the retail prices, the wholesale price, and the wholesale limitation into a string to add in a “record string”. The string to be displayed and the “record string” are sent to the Client 130. At Client 130, a page shown in FIG. 8 is generated to form a product shopping list. The client selects desired products on the shopping list and writes the order amount. Next, upload the order data. By analyzing the “record string”, obtain the amount of the client's order. When the corresponding amount is a legal number, according to the uploaded “record string”, the retail price, the wholesale price, and the wholesale limitation of the product can be obtained. By the way, the piece of product order price of the client can be accumulated immediately. Use the dialog box to display statistics signals as shown in FIG. 9. The Client 130 uploads the above mentioned data to the Server 110 to generate a page for the reservation order as shown in FIG. 10 to send back to the Client 130 to display. Meanwhile, provide to the client to replenish and modify. The modified data by the Client 130 is uploaded to the Server again. The Server 110 writes the received data into the database to generate the formal order. Finally, the order is sent to the Client 130 to display, as shown in FIG. 11.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An implement method suitable for detailed list shopping mode in B to B web site products comprising:
a Server writing a product order signal to be displayed into a display string and downloading to a Client;
clients of the Client writing and modifying an order data according to the display string, then uploading to the Server;
the Server registering the signal and storing the signal in a Session array to generate a reservation order and sending back to the Client;
the Client displaying the reservation order of the product and admitting the clients to modify related information; after the clients confirming, the reservation order reuploading to the Server again; and
after the Server receiving the reservation order, the reservation order written into a database of the Server and encrypted to store.

2. The implement method suitable for detailed list shopping mode in B to B web site products of claim 1 wherein the flow of the Server processing the display string further comprises:
connecting the database of the Server;
according to an ID logged in the web sites by the clients, counting an accumulative total amount of money of purchasing;
reading relative information from a product database and writing into strings to be displayed in turn;
recording a product ID corresponding to each product into a hidden control of the database of the Server;
composing a retail price, a wholesale price, and a wholesale limitation of each product into a string; and
adding the string into a record string of the database of the Server and displaying the string.

3. The implement method suitable for detailed list shopping mode in B to B web site products of claim 1 further comprising steps of product ordering and modifying signal display of the Client:
according to an ID logged into the web sites by the clients, showing a history data of the clients on web pages;
displaying product signals with a detailed list;
displaying a dialog box of relative information on the web pages;
the clients writing the order data;
uploading the product order data to the database of the Server, and analyzing a record string in the database to get a product ID;
according to the ID, confirming all the products are all checked;
according to a standard of a currency format, transforming a format of an accumulative amount of money;
displaying a total amount and a total amount of money of the order products; and uploading the order data to the database of the Server.

4. The implement method suitable for detailed list shopping mode in B to B web site products of claim 3 further comprising a step of displaying the product signal with a single product way selectively:
displaying the single product signal;
choosing the products to purchase;
setting a purchase amount of the product as 1; and
uploading the order data to the database of the Server.

5. The implement method suitable for detailed list shopping mode in B to B web site products of claim 3 further provides a cleaning function for displaying the dialog box of the relative information on the web pages.

6. The implement method suitable for detailed list shopping mode in B to B web site products of claim 3 wherein when the products aren't checked yet, following steps are included:
analyzing whether the order amount corresponding to the product ID is a logic number;
according to the product ID, analyzing the record string and getting the relative information;
counting the accumulative order amount of money of all the present product; and
increasing the product ID and going back to confirm checked.

7. The implement method suitable for detailed list shopping mode in B to B web site products of claim 3 wherein the history data comprises a total amount of money of past orders and preferential measures about the client.

8. The implement method suitable for detailed list shopping mode in B to B web site products of claim 3 wherein the dialog box can be a product name, a connecting route of product introducing, a product wholesale price, a product wholesale limitation, and an order amount of the product.

9. The implement method suitable for detailed list shopping mode in B to B web site products of claim 1 wherein the step of generating a reservation order comprises: according to the data uploaded from the Client, getting a total amount of the recorded products;
confirming the order data of all the products are processed;
reading the database of the Server to get a payment type and a freightage type of the client;
through the database of the Server, getting association signals of the client; and
downloading the order details of the product to the Client to display.

10. The implement method suitable for detailed list shopping mode in B to B web site products of claim 9 wherein when the order data of the product isn't processed, following steps are comprised:
gathering statistics order amount of money of the product;
counting a total amount and a total amount of money of the present order products;
writing an item number, a product number, an order amount, and a sale price of the product
order into the session array; and
getting the total amount of the recorded products.

11. The implement method suitable for detailed list shopping mode in B to B web site products of claim 10 wherein if the session array doesn't exist registered for recording the order data, write a first signal of the client ordering products into the session array and register the array through the session.

12. The implement method suitable for detailed list shopping mode in B to B web site products of claim I wherein the step of the Client showing the reservation order of the product further comprises:
displaying order details of the product in the reservation orders subsequently;
requesting to choose a payment type and an order type; and
renewing association signals of the client.

13. The implement method suitable for detailed list shopping mode in B to B web site products of claim 12 wherein the renewing association signals of the client further comprises a step of canceling the reservation order and going back to the product display page directly.

14. The implement method suitable for detailed list shopping mode in B to B web site products of claim 12 wherein the renewing association signals of the client further comprises confirming the reservation order and uploading the order details of the reservation order to the Server.

15. The implement method suitable for detailed list shopping mode in B to B web site products of claim 1 wherein the step of writing the reservation order into a database of the Server further comprises:
the Server getting the data uploaded from the Client;
encrypting a table to be operated in the database of the Server;
renewing the association signals of the client in the database;
according to the information of the order products, generating a new order and writing in an order database in the Server;
traversing a session array of recording order data;
confirming all the arrays are processed;
decrypting the table in the database;
deleting the session array for recording order data information;
according to the product order and the order details, a string is generated and to be
downloaded to the Client to display;
requesting to confirm the new order; and
downloading the string to the Client to display.

16. The implement method suitable for detailed list shopping mode in B to B web site products of claim 15 wherein when the array is not processed yet, following steps are comprised:
writing the order details of some product recorded in an item into an order detail database; and
increasing the array and going back to confirm checked.
